(19) United States
(12) Patent Application Publication
(10) Pub. No.: US 2008/0142149 A1
(43) Pub. Date: Jun. 19, 2008

(54) Setter Used in Firing and Method for Firing of Formed Honeycomb Body Using the Setter

(75) Inventors: Yasushi Noguchi, Aichi-prefecture (JP); Hiroyuki Suenobu, Aichi-prefecture (JP); Tomoo Nakamura, Cape Town (ZA); Takehiko Watanabe, Gifu-prefecture (JP)

Correspondence Address: OLIFF & BERRIDGE, PLC, P.O. BOX 320850, ALEXANDRIA, VA, 22320-4850, US

(73) Assignee: NGK INSULATORS, LTD., Nagoya-city (JP)

(21) Appl. No.: 11/663,479

(22) PCT Filed: Sep. 22, 2005
(86) PCT No.: PCT/JP05/17497

§ 371 Date: May 1, 2007

(30) Foreign Application Priority Data
Sep. 27, 2004 (JP) 2004-279669

(51) Int. Cl. C04B 35/64; C04B 35/195; F27D 3/12

(52) U.S. Cl. 156/89.22; 432/258

(57) ABSTRACT

A support plate for use in firing which has a main component of the crystal phase after firing being the same as that of an article to be sintered, and has a surface roughness (Ra) of the surface to be contacted with the article to be fired of 8 to 50 μm. A firing method using the above support plate is free from the breaking or chipping of cells of a honeycomb fired article as a product and also is free from the breaking thereof during firing, the staining or cells, the cracking or deformation thereof, or the failure of reaction, which is caused by the mismatch in expansion-shrinkage behavior, and thus allows the prevention of the decrease of the yield in the production of a honeycomb fired article as a product.

### TECHNICAL FIELD

The present invention relates to a setter used in firing and a method for firing of a formed honeycomb body using the setter.

### BACKGROUND ART

In firing, for example, a formed honeycomb body (a ceramic honeycomb structure) which is a green body, it has been a general practice, for example, to place a setter 6 on a refractory slab 10 and mount thereon a formed honeycomb body 20, as shown in FIG. 2, and conduct firing in a tunnel furnace or a periodical kiln. In this case, however, the formed honeycomb body receives, in the firing step, firing shrinkage and thermal expansion and, in the contact surface between the formed ceramic body and the setter, a friction is generated by the difference in firing shrinkage and thermal expansion between the formed ceramic body and the setter. This friction has caused a problem in that the formed honeycomb body after firing (the fired honeycomb body) has cracks at the contact surface or, even if no crack is generated, it is impossible to obtain a desired shrinkage at the contact surface and the formed honeycomb body after firing (the fired honeycomb body) is deformed.

In order to alleviate the above problem, there has been used, as a setter used in firing of a formed honeycomb body of large firing shrinkage, a formed material or fired material made of the same green body as for the formed honeycomb body to be fired, or a setter produced by slicing the formed honeycomb body into a given thickness and subjecting it to chamfering.

When there is used, as a setter, particularly one made of the same green body as for the formed honeycomb body, the setter shows, in firing, the same expansion and shrinkage as the formed honeycomb body; therefore, there can be prevented the generation of crack by firing, cell-deformation, cracking or deformation, all caused by the mismatching of expansion and shrinkage between the formed honeycomb body and the setter. Further, use of such a setter has provided an advantage that there is no undesired reaction which occurs by infiltration of heterogeneous composition into formed honeycomb body after firing (fired honeycomb body) and resultant contamination of fired honeycomb body.

When there is used a setter made of the same green body as for the formed honeycomb body, however, the formed honeycomb body and the setter stick to each other during sintering and, in the subsequent firing or cooling or in peeling of the formed honeycomb body after firing (the fired honeycomb body) from the setter which has sticked thereto, the fired honeycomb body (which is a product) has generated cell defects or lack of cells in some cases.

The present invention has been made in view of the above-mentioned problems of prior art and aims at providing:

a setter used in firing, which can strikingly reduce the sticking between the setter and a fired honeycomb body (a product) and accordingly can produce a product free from cell defects or lack of cells and also free from the crack by firing, cell-deformation, cracking, deformation or undesired reaction, all caused by the mismatching of expansion and shrinkage between the setter and a material to be fired together with the setter, and which can prevent a reduction in yield in production of a fired honeycomb body (a product), and

a method for firing of a formed honeycomb body using the setter.

### DISCLOSURE OF THE INVENTION

In order to achieve the above aim, the present invention provides the following setter used in firing and the following method for firing of a formed honeycomb body using the setter.

According to the present invention, there is provided a setter used in firing, which, when fired, forms a crystalline phase comprising the same main component as in the crystalline phase formed when a to-be-fired body is fired together with the setter and which has a surface roughness Ra of 8 to 50 μm at the surface to come in contact with the to-be-fired body.

The setter used in firing, of the present invention is preferably constituted by a formed ceramic body of honeycomb structure having an opening ratio of 50 to 90%.

In the setter used in firing, of the present invention, it is preferred that the crystalline phase formed when fired together with the to-be-fired body comprises, as the main component, any of (1) cordierite 85 to 100 mass %, (2) silicon carbide 50 to 100 mass % and (3) aluminum titanate 50 to 100 mass %.

The setter used in firing, of the present invention preferably has a porosity of 20 to 70% when fired together with the to-be-fired body.

The setter used in firing, of the present invention is preferred to satisfy at least one of the following conditions (1) to (3).

(1) The present setter has a diameter equal to the diameter of the to-be-fired body plus or minus 10% thereof and a thickness of 5 to 50 mm.
(2) The present setter is chamfered by a distance of 3 to 30 mm at the periphery of the surface to come into contact with the to-be-fired body, in a direction from the periphery toward the center of the surface.
(3) The to-be-fired body has a shape of 140 to 400 mm in diameter and 150 to 400 mm in height.

According to the present invention, there is also provided a method for firing of a formed honeycomb body using the above-mentioned setter used in firing.

### BRIEF DESCRIPTION OF THE DRAWINGS

FIG. 1(a) is a key portion sectional view showing a setter used in firing.

FIG. 1(b) is a schematic perspective view showing a setter used in firing.

FIG. 2 shows a state in which a refractory slab, a setter used in firing, and a formed honeycomb body have been arranged for firing of the formed honeycomb body.

### EXPLANATION OF SYMBOLS

1 is a setter used in firing, of the present invention; 6 is a conventional setter used in firing; 10 is a refractory slab; and 20 is a formed honeycomb body.

### BEST MODE FOR CARRYING OUT THE INVENTION

In-depth description is made below on the setter used in firing and the method for firing a formed honeycomb body using the setter, both of the present invention. However, the present invention should not be construed to be restricted thereto, and there can be added various changes, modifications and improvements based on the knowledge possessed by those skilled in the art as long as there is no deviation from the scope of the present invention.

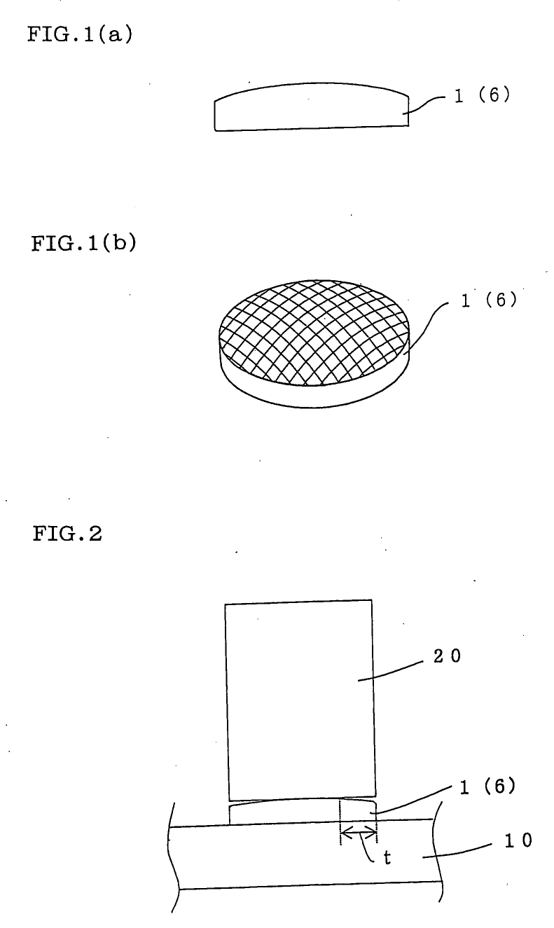

FIG. 1(a) is a key portion sectional view showing a setter used in firing; FIG. 1(b) is a schematic perspective view showing a setter used in firing; and FIG. 2 shows a state in which a refractory slab, a setter used in firing, and a formed honeycomb body have been arranged for firing of the formed honeycomb body.

The main characteristics of the setter used in firing, of the present invention lie in that the setter, when fired, form a a crystalline phase comprising the same main component as in the crystalline phase formed when a to-be-fired body is fired together with the setter and that the setter has a surface roughness Ra of 8 to 50 μm, preferably 10 to 30 μm at the surface to come in contact with the to-be-firmed material [reference is made to FIGS. 1(a) and 1(b)].

The reason is as follows. When the setter has a surface roughness Ra of less than 8 μm at the surface to come in contact with the to-be-firmed material (formed honeycomb body), the fired honeycomb body (product) sticks to the setter in peeling of fired honeycomb body (product) from setter, making large the damage (in particular, rib breakage) of fired honeycomb body (product). Meanwhile, when the setter has a surface roughness Ra of more than 50 μm at the surface to come in contact with the to-be-firmed material (formed honeycomb body), the fired honeycomb body (product) has a rough surface at the end surface being in contact with the setter.

Thereby, the sticking between the present setter used in firing and the fired honeycomb body (product) can be reduced greatly; as a result, the present setter can produce a fired honeycomb body (product) which is free from cell defects or lack of cells and also free from the crack by firing, cell-deformation, cracking, deformation or undesired reaction, all caused by the mismatching of expansion and shrinkage between the setter and the material to be fired together with the setter, and can prevent a reduction in yield in production of a fired honeycomb body (product).

Here, in the present setter used in firing, it is preferred that the crystalline phase formed when fired comprises the same main component as in the crystalline phase formed when the to-be-fired body (formed honeycomb body) is fired together with the setter and that the present setter is constituted by a formed ceramic body of honeycomb structure having an opening ratio of 50 to 90%, preferably 55 to 85%. The reason is as follows. When the opening ratio of the setter is less than 50%, the fired honeycomb body obtained as a product sticks to the setter when the former is removed from the latter, and the lower end face of the fired honeycomb body (product) is broken partially. Meanwhile, when the opening ratio of the setter is more than 90%, the setter is low in strength and is broken to pieces when the fired honeycomb body (product) is separated from the setter; therefore, there become necessary the removal (by polishing) of fragments sticking to the lower end face of fired honeycomb body (product) and the cleaning of kiln inside, resulting in reduced productivity.

Incidentally, the opening ratio is indicated by A/Sx100 when the sectional area of honeycomb structure in a direction perpendicular to the flow path is taken as S and the area of openings in the sectional area is taken as A.

In the present setter used in firing, it is further preferred that the crystalline phase formed when fired together with the to-be-fired body (formed honeycomb body) comprises, as the main component, any of (1) cordierite 85 to 100 mass %, (2) silicon carbide 50 to 100 mass % and (3) aluminum titanate 50 to 100 mass %. The reason is as follows. By allowing the crystalline phase formed when the setter has been fired, to comprise the same main component as in the crystalline phase of fired honeycomb body (product), there can be prevented the generation of crack by firing, cell-deformation, cracking or deformation, all caused by the mismatching of expansion and shrinkage between the setter and the to-be-fired body and there can also be prevented the generation of undesired reaction which is caused by penetration of heterogeneous composition into formed honeycomb body after firing (i.e. fired honeycomb body) and resultant contamination.

It is also preferred that the present setter used in firing has a porosity of 20 to 70% when fired together with the to-be-fired body (i.e. formed honeycomb body). The reason is as follows. When the porosity of the setter is less than 20%, the fired honeycomb body (product) tends to stick to the setter. Meanwhile, when the porosity of the setter is more than 70%, the fired honeycomb body (product) is unlikely to stick to the setter; however, the setter is low in strength and is broken to pieces when the fired honeycomb body (product) is separated from the setter, which necessitates the removal (by polishing) of fragments sticking to the lower end face of fired honeycomb body (product) and the cleaning of kiln inside, resulting in reduced productivity.

It is further preferred that the present setter used in firing has a diameter equal to the diameter of the to-be-fired body (i.e. formed honeycomb body) plus or minus 10% thereof and a thickness of 5 to 50 mm, preferably 10 to 40 mm. The reason is as follows. When the diameter of the setter is more than “a diameter equal to the diameter of the to-be-fired body (i.e. formed honeycomb body) plus 10% thereof”, the number of to-be-fired bodies settable in kiln is smaller, resulting in reduced productivity. Meanwhile, when the diameter of the setter is less than “a diameter equal to the diameter of the to-be-fired body (i.e. formed honeycomb body) minus 10% thereof”, the formed honeycomb body is not in contact with the setter and accordingly the lower end face of the honeycomb structure after firing (product) sags. When the thickness of the setter is more than 50 mm, the heat generated during binder combustion is large, generating cracks inside the fired honeycomb body (product). Meanwhile, when the thickness of the setter is less than 5 mm, the setter is low in strength, which makes the setter easy to break and requires the cleaning of kiln inside in taking out the product from the kiln.

It is furthermore preferred that the present setter used in firing is chamfered by a distance of 3 to 30 mm, preferably 5 to 20 mm at the periphery of the surface to come into contact with the to-be-fired body (i.e. formed honeycomb body), in a direction from the periphery toward the center of the surface (reference is made to “t” of FIG. 1). The reason is as follows. When the distance of chamfering is less than 3 mm, the cells at the outermost portion of honeycomb structure after firing (product) are deformed. Meanwhile, when the distance of chamfering is more than 30 mm, the formed honeycomb body is not in contact with the setter and therefore the lower end face of the honeycomb structure after firing (product) sags.

Incidentally, the present setter can be preferably used in firing of a to-be-fired body (i.e. a formed honeycomb body) having a shape of 140 to 400 mm in diameter and 150 to 400 mm in height.

The present invention is described in more detail by way of Examples. However, the present invention is in no way restricted to these Examples.

### (Measurement Methods)

### (1) Surface Roughness Ra

Using a surface roughness tester (Model FTS-S4C, a product of TAILER HOBSON LTD.), the stylus of 2 μm R at the front end was allowed to contact with the surface of a sample setter to come in contact with a product, at a front end angle of 90° over a length of 2.5 mm, and the surface roughness Ra of the sample setter was obtained from the examined profile of the above surface. The surface roughness Ra in the present invention was calculated from the average of the above measurements for ten locations.

### (2) Opening Ratio

The rib thickness and cell pitch of test sample were measured at 20 locations using an optical microscope and were each calculated for average. An opening area per cell was calculated from the averages, and an opening ratio was calculated.

### (3) Porosity

A test sample was measured for total pore volume using a mercury porosimeter (a product of MICROMELITICS LTD.). From this total pore volume and the true specific gravity (2.52 g/cc) of cordierite was calculated a porosity of the test sample.

### EXAMPLES 1˜13 AND COMPARATIVE EXAMPLES 1˜3

There were mixed talc (average particle diameter: 25 μm), kaolin (average particle diameter: 5 μm), alumina (average particle diameter: 5 μm), aluminum hydroxide (average particle diameter: 5 μm) and fused silica (average particle diameter: 30 μm) at proportions of talc 40 mass %, kaolin 20 mass %, alumina 15 mass %, aluminum hydroxide 15 mass % and fused silica 10 mass %, to prepare raw materials for cordierite formation (see Table 1).

Into a kneader were placed, as shown in Table 1, 100 parts by weight of one of the above-prepared raw materials for cordierite formation, a given amount of a foamed resin made of an acrylonitrile-methyl methacrylate copolymer, a given amount of a binder (hydroxypropyl methyl cellulose) and a given amount of a surfactant (potassium laurate soap), followed by kneading, to obtain plastic raw materials (batch Nos. 1 to 3). Each plastic raw material was formed into a cylindrical puddle using a vacuum pug mill and the puddle was fed into an extruder to obtain formed honeycomb bodies each having a diameter (setter diameter) shown in Table 2.

TABLE 1

| | Raw materials for cordierite formation | | | | | | | | |
|---|---|---|---|---|---|---|---|---|---|
| Batch | | | | Aluminium | Fused | | | | |
| No. | Talc | Kaolin | Alumina | hydroxide | silica | Foamed resin | Binder | Surfactant | Water |
| 1 | 40(25 μm) | 20(5 μm) | 15(5 μm) | 15(5 μm) | 10(30 μm) | 1.5(40 μm) | 6 | 0.2 | 33.5 |
| 2 | 40(25 μm) | 20(5 μm) | 15(5 μm) | 15(5 μm) | 10(30 μm) | 2.0(40 μm) | 6 | 0.2 | 34.0 |
| 3 | 40(25 μm) | 20(5 μm) | 15(5 μm) | 15(5 μm) | 10(30 μm) | 2.5(40 μm) | 6 | 0.2 | 35.0 |

[Unit = mass %]
The figure inside each parenthesis ( ) indicates an average particle diameter of each raw material.

Each formed honeycomb body obtained was subjected to dielectric drying and then to hot-air drying to absolute dryness, after which the dried formed honeycomb body was cut in parallel in a thickness (setter thickness) shown in Table 2, using a two blade metal-bonded abrasive. Of the two cut surfaces, the surface to come in contact with a formed honeycomb body (a to-be-fired body) was subjected to a finishing operation using a sand paper shown in Table 2; then, the resulting material was chamfered (R chamfering) at the periphery (see “t” of FIG. 2) using an abrasive, as shown in Table 2, to produce individual setters used in firing [see FIGS. 1(a) and 1(b)] (Examples 1 to 13 and Comparative Examples 1 to 3).

Separately, using slurries each made of a raw material for cordierite formation, of the same composition, there were prepared cylindrical formed honeycomb bodies (to-be-fired bodies) (batch Nos. 1 to 3) which had through-holes (cells) each plugged at either one end so that each end face of the formed honeycomb body looked checkered.

Next, as shown in FIG. 2, a setter 1 was placed on a refractory slab 10 and a formed honeycomb body 20 was mounted thereon. Then, firing was conducted at the maximum temperature of 1,420° C. for 5 hours to obtain, from each formed honeycomb body, ten honeycomb structures (products) of 280 mm (diameter), 305 mm (length), 300 μm (rib thickness) and 1.47 mm (cell pitch) [300 cells/in.² (cell number)](Examples 1 to 13 and Comparative Examples 1 to 3). Each honeycomb structure (product) was evaluated. The results are shown in Table 2.

TABLE 2

| | | | Surface | | | | Porosity | | | |
|---|---|---|---|---|---|---|---|---|---|---|
| | | Sand | roughness | Rib | Cell | Opening | after | Setter | Setter | Chamfering (R) |
| | Batch | paper | Ra | thickness | pitch | ratio | firing | diameter | thickness | distance of |
| | No. | treatment | (μm) | (μm) | (mm) | (%) | (%) | (mm) | (mm) | setter |
| Example 1 | 1 | #400 | 8.3 | 300 | 1.47 | 63 | 58 | 280 | 20 | Peripheral portion 10 mm |
| Example 2 | 1 | #200 | 10.5 | 300 | 1.47 | 63 | 58 | 280 | 20 | Peripheral portion 10 mm |
| Example 3 | 1 | #80 | 12.8 | 300 | 1.47 | 63 | 58 | 280 | 20 | Peripheral portion 10 mm |
| Example 4 | 2 | #400 | 8.4 | 300 | 1.47 | 63 | 66 | 280 | 20 | Peripheral portion 10 mm |
| Example 5 | 3 | #400 | 8.3 | 300 | 1.47 | 63 | 72 | 280 | 20 | Peripheral portion 10 mm |
| Example 6 | 1 | #400 | 8.3 | 380 | 1.47 | 55 | 58 | 280 | 20 | Peripheral portion 10 mm |
| Example 7 | 1 | #400 | 8.3 | 550 | 1.80 | 48 | 58 | 280 | 20 | Peripheral portion 10 mm |
| Example 8 | 1 | #400 | 8.3 | 300 | 1.47 | 63 | 58 | 240 | 20 | Peripheral portion 10 mm |
| Example 9 | 1 | #400 | 8.3 | 300 | 1.47 | 63 | 58 | 320 | 20 | Peripheral portion 10 mm |
| Example 10 | 1 | #400 | 8.3 | 300 | 1.47 | 63 | 58 | 280 | 3 | Peripheral portion 10 mm |
| Example 11 | 1 | #400 | 8.3 | 300 | 1.47 | 63 | 58 | 280 | 60 | Peripheral portion 10 mm |
| Example 12 | 1 | #400 | 8.3 | 300 | 1.47 | 63 | 58 | 280 | 20 | No confering |
| Example 13 | 1 | #400 | 8.3 | 300 | 1.47 | 63 | 58 | 280 | 20 | Peripheral portion 50 mm |
| Comparative | 1 | #1000 | 7.5 | 300 | 1.47 | 63 | 58 | 280 | 20 | Peripheral portion 10 mm |
| Example 1 | | | | | | | | | | |
| Comparative | 1 | #2000 | 6.4 | 300 | 1.47 | 63 | 58 | 280 | 20 | Peripheral portion 10 mm |
| Example 2 | | | | | | | | | | |
| Comparative | 1 | #24 | 54.7 | 300 | 1.47 | 63 | 58 | 280 | 20 | Peripheral portion 10 mm |
| Example 3 | | (Abrasive | | | | | | | | |
| | | treatment) | | | | | | | | |

| | Number of | Condition | |
|---|---|---|---|
| | products | of | |
| | which caused | product | |
| | rib defects | end face | Special comment |
| Example 1 | 0 | Very good | — |
| Example 2 | 0 | Very good | — |
| Example 3 | 0 | Very good | — |
| Example 4 | 0 | Very good | — |
| Example 5 | 0 | Good | A large number of small fragments of setter sticked to the |
| | | | product. |
| Example 6 | 0 | Very good | — |
| Example 7 | 0 | Very good | The area of sticking between setter and product was large. |
| | | | A longer time was needed for separation of setter from |
| | | | product. |
| Example 8 | 0 | Good | The portion of product end face not in contact with setter |
| | | | sagged. |
| Example 9 | 0 | Very good | The number of setting was smaller. |
| Example 10 | 0 | Very good | The setter had been broken when the product was taken out |
| | | | from the kiln, which necessitated the cleaning of kiln |
| | | | inside. |
| Example 11 | 0 | Very good | There were four inside defects. |
| Example 12 | 0 | Good | The product had cell deformation at the outermost portion. |
| Example 13 | 0 | Good | The portion of product end face not in contact with setter |
| | | | sagged. |
| Comparative | 7 | Bad | The area of sticking between setter and product was large. |
| Example 1 | | | A longer time was needed for separation of setter from |
| Comparative | 10 | Bad | product. |
| Example 2 | | | |
| Comparative | 0 | Bad | The end face of product was rough. |
| Example 3 | | | |

### Discussion

### Examples 1-13 and Comparative Examples 1-3

As is clear from the results of Table 2, in Examples 1 to 4 and Example 6, the condition of the honeycomb structure (product) at the surface being in contact with the setter, i.e. the condition of the lower end face of product was good and there was no problem.

Meanwhile, in Example 5, the honeycomb structure (product) had neither crack nor breakage and showed no problem in actual use. However, since the setter had a large porosity, a large number of fragments of the setter sticked to the lower end face of the honeycomb structure, which necessitated polishing of the lower end face of the honeycomb structure with a sand paper.

In Example 7, the honeycomb structure (product) had neither crack nor breakage and its condition at the surface being in contact with the setter, i.e. its condition at lower end face was good. However, the setter had a small opening ratio, its contact area with the product was large, and the area of the sticking between the setter and the product was large; therefore, a longer time than usual was needed for separation of the product from the setter.

In each of Example 8 and Example 9, the honeycomb structure (product) had neither crack nor breakage and its condition at the surface being in contact with the setter, i.e. its condition at lower end face was good. However, in Example 8, since the setter had a smaller diameter than the honeycomb structure (Product), the lower end face of the honeycomb structure (product) sagged; in Example 9, since the setter had too large a diameter, the number of to-be-fired bodies settable in kiln decreased, resulting in reduced productivity.

In Example 10, the honeycomb structure (product) had neither crack nor breakage and its condition at the surface being in contact with the setter, i.e. its condition at lower end face was good. However, since the setter had too small a thickness and showed cracking in taking-out of product from kiln, the cleaning of kiln inside was necessary. In Example 11, the surface (lower end face) condition of the honeycomb structure (product) was good and the lower end face had neither crack nor breakage; however, since the setter had too large a thickness, four of the ten honeycomb structures (products) had interior cracks generated during firing.

In each of Example 12 and Example 13, the honeycomb structure (product) had neither crack nor breakage and showed no problem in actual use. However, in Example 12, the outermost cells of the honeycomb structure (product) deformed; in Example 13, since the setter had too large a chamfered portion and the formed honeycomb body was not in contact with the setter, the lower end face of the honeycomb structure after firing (product) sagged.

In each of Comparative Example 1 and Comparative Example 2, since the surface roughness Ra of the setter was less than 8 μm, the condition of the honeycomb structure (product) at the surface being in contact with the setter, i.e. the condition of the lower end face of product was outside the allowable range, the honeycomb structure (product) showed rib cracks, and the sticking between the setter and the product was seen in many places.

In Comparative Example 3, the setter had a surface roughness Ra of larger than 50 μm; therefore, the condition of the honeycomb structure (product) at the surface being in contact with the setter, i.e. the condition of the lower end face of product was outside the allowable range, and the lower end face of the honeycomb structure (product) was rough in an extent that the roughness could be confirmed visually.

### EXAMPLES 14˜22 AND COMPARATIVE EXAMPLES 4˜5

To a silicon carbide powder was added an organic binder (methyl cellulose and hydroxypropyl methyl cellulose). Thereto were added a surfactant and water to prepare plastic puddles. The plastic puddles were extruded to obtain formed materials of honeycomb structure.

Each formed honeycomb body was subjected to dielectric drying and then to hot-air drying to absolute dryness. The resulting material was cut in parallel in a thickness (setter thickness) shown in Table 3, using a two blade metal-bonded abrasive. Of the two cut surfaces, the surface to come in contact with a formed honeycomb body (a to-be-fired body) was subjected to a finishing operation using a sand paper shown in Table 3; then, the resulting material was chamfered (R chamfering) at the periphery (see “t” of FIG. 2) using an abrasive, as shown in Table 2, to produce individual setters used in firing [see FIGS. 1(a) and 1(b)] (Examples 14 to 22 and Comparative Examples 4 and 5).

Separately, using slurries of the same compositions, there were prepared cylindrical formed honeycomb silicon carbide materials (to-be-fired bodies) which had through-holes (cells) each plugged at either one end so that each end face of the formed honeycomb body looked checkered.

Next, as shown in FIG. 2, a setter 1 was placed on a refractory slab 10 and a formed honeycomb body 20 was mounted thereon. Then, firing was conducted at the maximum temperature of 1,420° C. for 5 hours to obtain, from each formed honeycomb body, ten honeycomb structures (products) of 280 mm (diameter), 305 mm (length), 300 μm (rib thickness) and 1.47 mm (cell pitch) [300 cells/in.² (cell number)] (Examples 14 to 22 and Comparative Examples 1 to 3). Each honeycomb silicon carbide structure (product) was evaluated.

The results are shown in Table 3.

TABLE 3

| | | Surface | | | | Porosity | | |
|---|---|---|---|---|---|---|---|---|
| | Sand | roughness | Rib | Cell | Opening | after | Setter | Setter |
| | paper | Ra | thickness | pitch | ratio | firing | diameter | thickness |
| | treatment | (μm) | (μm) | (mm) | (%) | (%) | (mm) | (mm) |
| Example 14 | #400 | 8.5 | 550 | 1.80 | 48 | 58 | 280 | 20 |
| Example 15 | #400 | 8.5 | 300 | 1.47 | 63 | 58 | 280 | 20 |
| Example 16 | #80 | 12.9 | 300 | 1.47 | 63 | 58 | 280 | 20 |
| Example 17 | #400 | 8.5 | 300 | 1.47 | 63 | 58 | 240 | 20 |
| Example 18 | #400 | 8.5 | 300 | 1.47 | 63 | 58 | 320 | 20 |
| Example 19 | #400 | 8.5 | 300 | 1.47 | 63 | 58 | 280 | 3 |
| Example 20 | #400 | 8.5 | 300 | 1.47 | 63 | 58 | 280 | 60 |
| Example 21 | #400 | 8.5 | 300 | 1.47 | 63 | 58 | 280 | 20 |
| Example 22 | #400 | 8.5 | 300 | 1.47 | 63 | 58 | 280 | 20 |
| Comparative | #1000 | 7.4 | 300 | 1.47 | 63 | 58 | 280 | 20 |
| Example 4 | | | | | | | | |
| Comparative | #24 | 54.5 | 300 | 1.47 | 63 | 58 | 280 | 20 |
| Example 5 | | | | | | | | |

| | | Number of | | |
|---|---|---|---|---|
| | | products | | |
| | | which | Condition | |
| | Chamfering (R) | caused | of | |
| | distance of | rib | product | |
| | setter | defects | end face | Special comment |
| Example 14 | Peripheral | 0 | Good | The sticking between product |
| | portion 10 mm | | | and setter was seen slightly. |
| Example 15 | Peripheral | 0 | Very good | — |
| | portion 10 mm | | | |
| Example 16 | Peripheral | 0 | Very good | — |
| | portion 10 mm | | | |
| Example 17 | Peripheral | 0 | Good | The portion of product end face |
| | portion 10 mm | | | not in contact with setter |
| | | | | sagged. |
| Example 18 | Peripheral | 0 | Very good | The number of setting was |
| | portion 10 mm | | | smaller. |
| Example 19 | Peripheral | 0 | Very good | — |
| | portion 10 mm | | | |
| Example 20 | Peripheral | 0 | Very good | — |
| | portion 10 mm | | | |
| Example 21 | No confering | 0 | Good | The product had cell |
| | | | | deformation at the outermost |
| | | | | portion. |
| Example 22 | Peripheral | 0 | Good | The portion of product end face |
| | portion 50 mm | | | not in contact with setter |
| | | | | sagged. |
| Comparative | Peripheral | 5 | Bad | The sticking between setter and |
| Example 4 | portion 10 mm | | | product was seen in many |
| | | | | places. |
| Comparative | Peripheral | 0 | Bad | The end face of product was |
| Example 5 | portion 10 mm | | | rough. |

### Discussion

### Examples 14-22 and Comparative Examples 4-5

As is clear from the results of Table 3, in Example 14, the condition of the honeycomb structure (product) at the surface being in contact with the setter, i.e. its condition at lower end face was acceptable; however, the setter had a small opening ratio, its contact area with the product was large, and the sticking between the setter and the product was seen slightly.

Meanwhile, in each of Example 15 and Example 16, the condition of the honeycomb structure (product) at the surface being in contact with the setter was good. In Example 16, in particular, the surface roughness was inferior to Example 15 but there was no problem.

In Example 17, the condition of the honeycomb structure (product) at the surface being in contact with the setter, i.e. its condition at lower end face was acceptable; however, since the setter had a diameter smaller than the honeycomb structure (product), the lower end face of the honeycomb structure sagged. In Example 18, the condition of the honeycomb structure (product) at the surface being in contact with the setter, i.e. its condition at lower end face was good; however, since the setter had too large a diameter, the number of to-be-fired bodies settable in kiln was smaller, resulting in reduced productivity.

In each of Example 19 and Example 20, the condition of the honeycomb structure (product) at the surface being in contact with the setter, i.e. its condition at lower end face was good when the thickness of setter was in a range of 3 to 60 mm, and there was no problem.

In each of Example 21 and Example 22, the condition of the honeycomb structure (product) at the surface being in contact with the setter, i.e. its condition at lower end face was acceptable. However, in Example 21, since no chamfering was made for the setter, the outermost cells of the honeycomb structure (product) deformed; in Example 22, since the chamfering portion of the setter was too large and the formed honeycomb body was not in contact with the setter, the lower end face of the honeycomb structure after firing (product) sagged.

In Comparative Example 4, the surface roughness Ra of the setter was less than 8 μm; therefore, the condition of the honeycomb structure (product) at the surface being in contact with the setter, i.e. the condition of the lower end face of product was outside the allowable range, the honeycomb structure (product) showed rib cracks, and the sticking between the setter and the product was seen in may places.

In Comparative Example 5, the setter had a surface roughness Ra of larger than 50 μm; therefore, the condition of the honeycomb structure (product) at the surface being in contact with the setter, i.e. the condition of the lower end face of product was outside the allowable range, and the lower end face of the honeycomb structure (product) was rough in an extent that the roughness could be confirmed visually.

### EXAMPLES 23˜31 AND COMPARATIVE EXAMPLES 6˜7

There were mixed α-alumina (average particle diameter: 5.0 μm, BET specific surface area: 0.8 m²/g), boehmite (average particle diameter: 0.1 μm, BET specific surface area: 163 m²/g), titanium oxide (average particle diameter: 0.2 μm) and high-purity kaolin (average particle diameter: 3 μm) to prepare raw materials for aluminum titanate (AT) formation. To 100 parts by mass of each raw material for AT formation was added 1.5 parts by mass of an organic binder (methyl cellulose and hydroxypropyl methyl cellulose). They were mixed and degassed in vacuum. The resulting mixture was cast in a gypsum form to obtain formed materials.

Each formed honeycomb body obtained was subjected to dielectric drying and then to hot-air drying to absolute dryness. The resulting material was cut in parallel in a thickness (setter thickness) shown in Table 4, using a two blade metal-bonded abrasive. Of the two cut surfaces, the surface to come in contact with a formed honeycomb body (a to-be-fired body) was subjected to a finishing operation using a sand paper shown in Table 4; then, the resulting material was chamfered (R chamfering) at the periphery (see “t” of FIG. 2) using an abrasive, as shown in Table 4, to produce individual setters used in firing [see FIGS. 1(a) and 1(b)] (Examples 23 to 31 and Comparative Examples 6 and 7).

Separately, using slurries of the same compositions, there were prepared cylindrical formed honeycomb aluminum titanate materials (to-be-fired bodies) which had through-holes (cells) each plugged at either one end so that each end face of the formed honeycomb body looked checkered.

Next, as shown in FIG. 2, a setter 1 was placed on a refractory slab 10 and a formed honeycomb body 20 was mounted thereon. Then, firing was conducted at the maximum temperature of 1,420° C. for 5 hours to obtain, from each formed honeycomb body, ten honeycomb structures (products) of 280 mm (diameter), 305 mm (length), 300 μm (rib thickness) and 1.47 mm (cell pitch) [300 cells/in.² (cell number)] (Examples 14 to 22 and Comparative Examples 1 to 3). Each honeycomb aluminum titanate structure (product) was evaluated. The results are shown in Table 4.

TABLE 4

| | | Surface | | | | Porosity | | |
|---|---|---|---|---|---|---|---|---|
| | Sand | roughness | Rib | Cell | Opening | after | Setter | Setter |
| | paper | Ra | thickness | pitch | ratio | firing | diameter | thickness |
| | treatment | (μm) | (μm) | (mm) | (%) | (%) | (mm) | (mm) |
| Example 23 | #400 | 8.1 | 550 | 1.80 | 48 | 58 | 280 | 20 |
| Example 24 | #400 | 8.1 | 300 | 1.47 | 63 | 58 | 280 | 20 |
| Example 25 | #80 | 12.4 | 300 | 1.47 | 63 | 58 | 280 | 20 |
| Example 26 | #400 | 8.1 | 300 | 1.47 | 63 | 58 | 240 | 20 |
| Example 27 | #400 | 8.1 | 300 | 1.47 | 63 | 58 | 320 | 20 |
| Example 28 | #400 | 8.1 | 300 | 1.47 | 63 | 58 | 280 | 3 |
| Example 29 | #400 | 8.1 | 300 | 1.47 | 63 | 58 | 280 | 60 |
| Example 30 | #400 | 8.1 | 300 | 1.47 | 63 | 58 | 280 | 20 |
| Example 31 | #400 | 8.1 | 300 | 1.47 | 63 | 58 | 280 | 20 |
| Comparative | #1000 | 7.2 | 300 | 1.47 | 63 | 58 | 280 | 20 |
| Example 6 | | | | | | | | |
| Comparative | #24 | 54.1 | 300 | 1.47 | 63 | 58 | 280 | 20 |
| Example 7 | | | | | | | | |

| | | Number of | | |
|---|---|---|---|---|
| | | products | | |
| | | which | Condition | |
| | Chamfering (R) | caused | of product | |
| | distance of setter | rib defects | end face | Special comment |
| Example 23 | Peripheral portion | 0 | Good | The sticking between product and setter |
| | 10 mm | | | was seen slightly. |
| Example 24 | Peripheral portion | 0 | Very good | — |
| | 10 mm | | | |
| Example 25 | Peripheral portion | 0 | Very good | — |
| | 10 mm | | | |
| Example 26 | Peripheral portion | 0 | Good | The portion of product end face not in |
| | 10 mm | | | contact with setter sagged. |
| Example 27 | Peripheral portion | 0 | Very good | The number of setting was smaller. |
| | 10 mm | | | |
| Example 28 | Peripheral portion | 0 | Very good | — |
| | 10 mm | | | |
| Example 29 | Peripheral portion | 0 | Very good | — |
| | 10 mm | | | |
| Example 30 | No confering | 0 | Good | The product had cell deformation at the |
| | | | | outermost portion. |
| Example 31 | Peripheral portion | 0 | Good | The portion of product end face not in |
| | 50 mm | | | contact with setter sagged. |
| Comparative | Peripheral portion | 9 | Bad | The sticking between setter and product |
| Example 6 | 10 mm | | | was seen in many places. |
| Comparative | Peripheral portion | 0 | Bad | The end face of product was rough. |
| Example 7 | 10 mm | | | |

### Discussion

### Examples 23-31 and Comparative Examples 6-7

As is clear from the results of Table 4, in Example 23, the condition of the honeycomb structure (product) at the surface being in contact with the setter, i.e. its condition at lower end face was acceptable; however, the setter had a small opening ratio, its contact area with the product was large, and the sticking between the setter and the product was seen slightly.

Meanwhile, in each of Example 24 and Example 25, the condition of the honeycomb structure (product) at the surface being in contact with the setter was good. In Example 25, in particular, the surface roughness was inferior to Example 15 but there was no problem.

In Example 26, the condition of the honeycomb structure (product) at the surface being in contact with the setter, i.e. its condition at lower end face was acceptable; however, since the setter had a diameter smaller than the honeycomb structure (product), the lower end face of the honeycomb structure sagged. In Example 27, the condition of the honeycomb structure (product) at the surface being in contact with the setter, i.e. its condition at lower end face was good; however, since the setter had too large a diameter, the number of to-be-fired bodies settable in kiln was smaller, resulting in reduced productivity.

In each of Example 28 and Example 29, the condition of the honeycomb structure (product) at the surface being in contact with the setter, i.e. its condition at lower end face was good when the thickness of setter was in a-range of 3 to 60 mm, and there was no problem.

In each of Example 30 and Example 31, the condition of the honeycomb structure (product) at the surface being in contact with the setter, i.e. its condition at lower end face was acceptable. However, in Example 30, since no chamfering was made for the setter, the outermost cells of the honeycomb structure (product) deformed; in Example 22, since the chamfering portion of the setter was too large and the formed honeycomb body was not in contact with the setter, the lower end face of the honeycomb structure after firing (product) sagged.

In Comparative Example 6, the surface roughness Ra of the setter was less than 8 μm; therefore, the condition of the honeycomb structure (product) at the surface being in contact with the setter, i.e. the condition of the lower end face of product was outside the allowable range, the honeycomb structure (product) showed rib cracks, and the sticking between the setter and the product was seen in many places.

In Comparative Example 7, the setter had a surface roughness Ra of larger than 50 μm; therefore, the condition of the honeycomb structure (product) at the surface being in contact with the setter, i.e. the condition of the lower end face of product was outside the allowable range, and the lower end face of the honeycomb structure (product) was rough in an extent that the roughness could be confirmed visually.

### INDUSTRIAL APPLICABILITY

The setter used in firing and the method for firing of a formed honeycomb body using the setter, both of the present invention can contribute to an improvement in yield in production of a fired honeycomb body (a product).

1. A setter used in firing, which, when fired, forms a crystalline phase comprising the same main component as in the crystalline phase formed when a to-be-fired body is fired together with the setter and which has a surface roughness Ra of 8 to 50 μm at the surface to come in contact with the to-be-fired body.

2. A setter used in firing, set forth in claim 1, which is constituted by a formed ceramic body of honeycomb structure having an opening ratio of 50 to 90%.

3. A setter used in firing, set forth in claim 1, wherein the crystalline phase formed when fired together with the to-be-fired body comprises, as the main component, any of (1) cordierite 85 to 100 mass %, (2) silicon carbide 50 to 100 mass % and (3) aluminum titanate 50 to 100 mass %.

4. A setter used in firing, set forth in claim 1, which has a porosity of 20 to 70% when fired together with the to-be-fired body.

5. A setter used in firing, set forth in claim 1, which has a diameter equal to the diameter of the to-be-fired body plus or minus 10% thereof and a thickness of 5 to 50 mm.

6. A setter used in firing, set forth in claim 5, which is chamfered by a distance of 3 to 30 mm at the periphery of the surface to come into contact with the to-be-fired body, in a direction from the periphery toward the center of the surface.

7. A setter used in firing, set forth in claim 5, wherein the to-be-firmed material has a shape of 140 to 400 mm in diameter and 150 to 400 mm in height.

8. A method for firing of a formed honeycomb body using a setter used in firing, set forth in claim 1.
